(19) United States
(12) Patent Application Publication
(10) Pub. No.: US 2023/0385869 A1
(43) Pub. Date: Nov. 30, 2023

(54) SYSTEM AND METHOD FOR AUTOMATIC DETERMINATION OF SIGN VISIBILITY

(71) Applicant: Digital Natives Ltd, Virgin Islands (VG)

(72) Inventor: Hussein Khader, Amman (JO)

(21) Appl. No.: 18/326,262

(22) Filed: May 31, 2023

Related U.S. Application Data
(60) Provisional application No. 63/347,258, filed on May 31, 2022.

(51) Int. Cl. G06Q 30/0242; G06T 7/10; G06T 7/73

(52) U.S. Cl. CPC G06Q 30/0242; G06T 7/10; G06T 7/74

(57) ABSTRACT

A system and method for a digital system managing a plurality of out of home displays comprising: receiving display positional data of a physical display; collecting image data based on location data of the display positional data; and determining a visibility index score for the physical display based in part on automated analysis of the image data.

### CROSS-REFERENCE TO RELATED APPLICATIONS

This Application claims the benefit of U.S. Provisional Application No. 63/347,258, filed on 31 May 2022, which is incorporated in its entirety by this reference.

### TECHNICAL FIELD

This invention relates generally to the field of Out of Home Measurement, and more specifically to a new and useful system and method for automatic determination of Out Of Home Display visibility.

### BACKGROUND OF THE INVENTION

Billboards, signs, and other forms of physical displays are widely used forms of advertising. Despite their widespread use, there is often very limited information on the potential reach of viewership of a display and/or an expected number of viewers for a given display advertisement.

Poor performance measurement solutions have also made it difficult to gain accurate insights into the effectiveness of such Out of Home (OOH) Displays. The lack of a reliable and standardized way of measuring OOH Displays makes it challenging for advertisers to make informed decisions on selecting the right OOH Display that will deliver optimal exposure for their message and content.

Furthermore, the extremely large number of OOH Displays can make it challenging to implement any solution that is scalable. Manual or human based solutions may involve human evaluations and ratings. This would be costly and time consuming. Additionally, it would be challenging to have any human solution be updated with enough frequency to account for changing conditions of an OOH Display.

Also, the different formats and the different installation method makes it challenging to determine the visibility of each Billboard or sign.

Thus, there is a need in the Out of Home Industry to create a new and useful system and method for automatic determination of Out Of Home Display visibility. This invention provides such a new and useful system and method.

### BRIEF DESCRIPTION OF DRAWINGS

FIG. 1 is a schematic representation of a system of one variation.

FIG. 2 is a flowchart representation of one method variation.

FIG. 3 is a flowchart representation of a method variation incorporating supplemental data.

FIG. 4 is a detailed flowchart representation of a method variation for billboards.

FIGS. 5A-5E are exemplary representations of different processes of the method.

FIG. 6 is an exemplary process used in one method variation.

FIG. 7 is a flowchart representation of a method variation applied across multiple displays.

FIG. 8 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

### 1. Overview

Systems and methods for automatic determination of an Out of Home (OOH) Display visibility function to employ automated processing of vast geographically mapped image data to determine metrics related to the visibility of an OOH Display and then to use those metrics in altering digital systems. In some variations, the systems and methods can involve the determination of visibility index scores for one or more displays. The systems and methods described herein may provide a scalable, reliable, and standardized way of measuring OOH Display visibility, enabling computer-enabled systems that can allow advertisers to make informed decisions on selecting the right OOH Display that may deliver enhanced exposure for their message and content.

Herein, “a display” is used as a descriptor for a static or digital OOH Display. This can include Billboards, Digital Billboards, Urban Panels, Spectacular, Bus Shelters, Place Based Media, street-level or pedestrian level displays, and the like.

Herein, a visibility index score is referenced as a characterization of given visibility attributes related to an OOH display. Such a visibility index score is a set of visibility metrics aggregated into one single value, such attributes may include size of an OOH display, height, contact zone, angle of a display relative to potential viewing locations, and/or other properties. In some variations, the systems and methods may additionally be used in determining the Opportunity To See (OTS) and The Likelihood To See (LTS), which may be based in part on visibility index scores. OTS may relate to the number of opportunities for a user see a display or potential audience. LTS may relate to the quality or predicted viewership of a display. Other OOH display assessments related to the viewability of an OOH display may additionally alternatively be used.

The systems and methods may be used for determination of OOH Display visibility for large format displays such as road-side billboards, or other forms of large displays like spectaculars. Additionally or alternatively, the systems and methods may be used for smaller format displays such as urban panels, pedestrian targeted displays, bus shelter displays, and the like. In a similar manner, the systems and methods may be used for outdoor OOH displays (e.g., roadside billboards, sporting arena advertising signs, etc.), but could additionally or alternatively be used for place-based media OOH (e.g., shopping mall, supermarket displays, elevators, airport, convention centers, etc.). The systems and methods may also be used for digital displays or static displays (e.g., printed billboards).

The systems and methods may be implemented as a digital or static Out of Home (D/OOH) display intelligence platform, by which determined visibility index scores may be accessed and used by external entities. In such variations, the systems and methods may provide various digital analytic-based features whereby a dashboard can be provided such that users can explore determined visibility metrics of D/OOH displays. The data collected on sign's Visibility Index may be used in training machine learning models, which may be further used in analyzing D/OOH Display and help both publishers and buyers to make more sound decision.

The system and method may be used to optimize revenues per D/OOH display. Publishers can adjust their rate cards or CPM to reflect the value of the visibility index. The system and method may be used to better model impact of different D/OOH display options and then automate management of advertising planning and buying campaigns. For example, given certain advertising campaign parameters, the system and method may be used to automatically book, schedule, or buy display based on the Visibility Index Values and subsequently OTS and LTS, across a network of multiple locations of D/OOH displays.

The systems and methods, of some variations, may be implemented to augment the performance and impact of a certain design to be used on a D/OOH display. In some variations, this may be used to enable automated digital graphic design tools. The design elements of an advertisement design can be tested using image properties (e.g., colors adjustment for enhanced contrast, geometric transformations for accounting for non-direct viewing, etc.), text properties (e.g., text/font sizing, textual content adjustment for limiting amount of content), and/or other aspects. In another variation, a dynamic design system could take a set of graphic assets and a base design template(s) and modify according to different D/OOH display visibility characteristics determined through the system and method. This may enable adaptive graphics for D/OOH.

The dynamic design features of the system and method may be used to modify digital display assets so that the visual appearance of a display add accounts for factors such as the primary angle of viewing the display, the expected amount of time/attention to read or contact zone or view, and/or other factors. For example, a sign on the side of a highway may have its design adjusted for quick impressions, while a sign with more visibility by pedestrians could dynamically be adjusted to present optional more-detailed advertisement text content.

The system and method may enable various dynamic design features to better improve display content for OOH displays. The dynamic design features of the system and method could include an interactive design editor that provides real-time visibility score feedback based on the changes made to a design. This tool could enable users to visually see the impact of their design choices on the overall visibility and effectiveness of the OOH display, facilitating more informed decision-making. In a similar variation, the system and method may provide automated design suggestions tailored to the specific visibility scores of the OOH display. Based on factors such as viewing angle, time constraints, and other contextual data, the tool could generate personalized recommendations for design improvements aimed at optimizing viewer attention and engagement.

In another variation, the system and method could offer a library of pre-built design templates that are optimized for various visibility scenarios. Users could select from these templates knowing they are already designed to account for factors such as primary viewing angle, expected viewing time, and other context-specific criteria indicated through the visibility index scores. This feature would streamline the design process while ensuring effective advertisements for a range of OOH display situations.

As another variation of design tool capabilities, dynamic design features of the system and method may provide design comparison and A/B testing tools that allow users to gauge the performance of different design variations based on visibility scores of planned OOH displays.

As described herein, different features and capabilities may be enabled by the system and method. In one variation, the systems and methods may take into account different times of day and varying weather conditions while determining the visibility index scores. By analyzing the impact of natural lighting, artificial lighting, and environmental factors such as fog, rain, or snow on visibility, the system can provide more accurate and dynamic visibility assessments for OOH Displays.

As another variation, the systems and methods may incorporate real-time traffic data to dynamically adjust the visibility index scores (or more likely derived LTS and OTS scores) and advertising content based on the number and type of viewers currently in the viewing area. This could allow for more targeted advertising and efficient resource utilization, ensuring that the display captures the attention of its intended audience at the right time.

The systems and methods, of some variations, may be implemented in connection with a marketplace such that it intelligently manages the dynamic bidding for a D/OOH display, such as allowing the bidder to increase bidding value for D/OOH displays with higher visibility index versus decreasing or limiting the bidder to higher rates for a D/OOH display with a lower visibility index.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one potential benefit, the systems and methods may enable an automated way of interpreting viewing properties of D/OOH display. The systems and methods can implement such assessment based on a source dataset of D/OOH display locations. This may be implemented nationwide and globally.

As another potential benefit, the systems and methods may be adaptive and resilient to working with varying amounts of image data from the area near a display. There can be varying numbers of images of a sign and varying diversity of types of images (different angles, different qualities). The systems and methods can address such challenges to still provide comparable accurate visibility index scores across different D/OOH displays and locations.

As another potential benefit, the systems and methods may incorporate additional supplemental factors into the visibility index score enabling additional profiling of a display. For example, with road information, speed and traffic information, while identifying the Contact zone of a billboard, the systems and methods may help identify dwell time, which greatly affect Opportunity To See (OTS) and Likelihood To See (LTS).

### 2. System

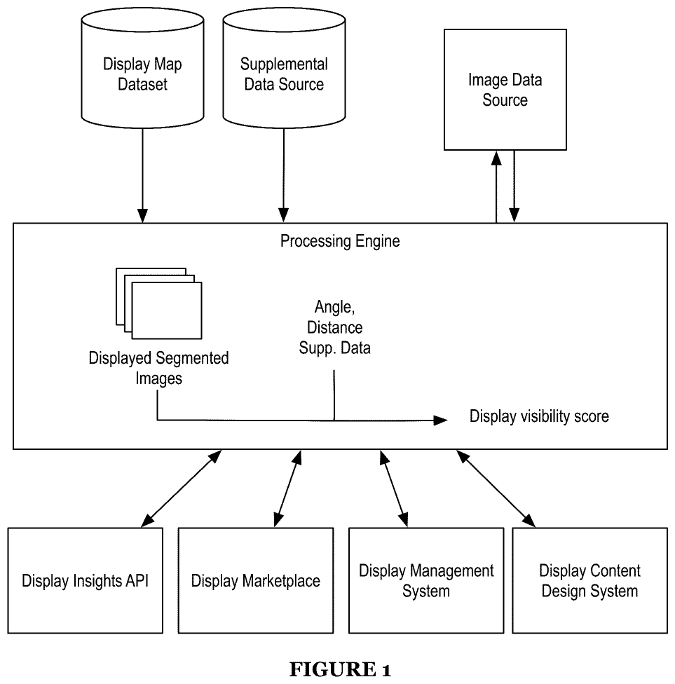

As shown in FIG. 1, a system for automatic determination of a D/OOH display visibility can include a display map dataset 110, a distributed image data source 120, and a processing engine 130 configured to output a visibility index score 140 for at least one display in the display map dataset. The processing engine can include one or more processors with one or more computer-readable mediums (e.g., non-transitory computer-readable mediums) storing instructions that, when executed by the one or more computer processors, cause the system to perform operations related to determining a visibility index score for a display and/or other processes described herein. More specifically, in some variations, the operations may be used to determine the visibility index scores for a plurality of displays.

The system may additionally include one or more supplemental data sources. Additionally, the system may additionally include one or more components that can integrate the visibility index score in altering operation of the system such as a marketplace, a programmatic interface, a display analysis dashboard interface, and/or a display design testing tool. The display map dataset and/or the supplemental data source may function as a data collection module or any suitable combination of database or data access subsystems. The data collection module may function to collect data related to different D/OOH display instances. This may include but is not limited to location data, physical characteristics of the displays, imagery of displays, surrounding environmental conditions, and traffic data. The data collection module may utilize various data sources such as GPS data, satellite imagery, weather data, and traffic monitoring systems.

The display map dataset functions to provide a set of data associating a set of locations with displays. The display map dataset, in one variation, can include geographic coordinates for the location of different displays. For example, the display map dataset can include latitude and longitude coordinates of a display.

The display map dataset may additionally or alternatively include location information customized to the type of environment such as an internal building environment for displays within a building. For example, displays within a shopping mall could include coordinate properties characterizing the floorplan-based location of a display within a shopping mall.

The display map dataset may additionally include or be associated with other display information such as display properties like aspect ratio, dimensions, size, shape, width/height of display surface, direction of the display, display elevation, and/or other display properties. The display properties can include information on one or more potential display features such as if the display has lighting.

The display map dataset can additionally include usage information. For example, the display map dataset may include data records of the currently displayed advertisement(s) for a display and/or a historical data record of current/past advertisements. This may be used in detecting and identifying a display in image data of the distributed image dataset. In one variation, historical data records of previous display content may be used to differentiate multiple signs detected in the image data. In another variation, historical data records may be used to locate a sign in the image data when there is inaccurate or low resolution information on sign position.

In one variation, the display map dataset may be collected and managed within a digital platform. For example, a digital platform may be operated enabling the managers or owners of D/OOH displays to add, edit, and/or otherwise manage the different display offerings. For example, an entity operating a plurality of D/OOH displays can add a profile for each D/OOH display indicating its location and display parameters. In another variation, the display map dataset may be accessed from an outside source using some interface such as an application programming interface (API).

The distributed image data source functions to provide a set of collected image data from various geographic locations which can be used as a source of interpreting visibility of displays.

The collected image data is used as data input for computer-vision based analysis of context related to the visibility of a D/OOH display.

The image data is preferably tagged, mapped, and/or otherwise associated with a location. Location information may be used to relate a set of image data to a D/OOH display at or near the location. In some variations, the location is geolocation—latitude and longitude. In some variations, the location information may be defined in an alternative form but preferably one shared with location information of a D/OOH display so that image data from near a D/OOH display location can be selectively analyzed. Given a specific location (of a D/OOH display of interest), the distributed data source can provide visual and/or spatial information related to the visibility conditions.

The distributed image data source may be a managed database of image data. The distributed image data source may more generally be a data interface to one or more external data sources. For example, the system may be implemented using an API or other form of access to image data.

The distributed image data source preferably has a coverage area of the relevant geographic area of interest. In some cases, this may be a nationwide or even global are of coverage. In other variations, the coverage may be localized to a particular region or even environment such as a particular building like a shopping mall, convention center, airport, etc.

The distributed image data source in one variation is a collection of image data from a digital mapping service. Such image data source may alternatively be described as street-level or pedestrian-view image data (i.e., ground level. For example, the distributed image data source may include image data collected from roadways as part of a mapping data resource. In another example, the distributed image data may be a large body of collected images that include geographic location information. These could include an accessible photographic database with geo-tagged images.

The distributed image data source may additionally or alternatively include or use satellite images, topographic mapping data, geographic modeling datasets, and/or other datasets that may be used to interpret or model environmental conditions in the vicinity of different D/OOH displays.

While at least one distributed image data source is used, the system may additionally include multiple types of data sources that can be used in combination.

For a given display, the distributed image data source is preferably used to retrieve a set of images in near proximity to the location of the display. Determining images in proximity to a display may be based on a fixed distance threshold but may additionally or alternatively be based on predicted visibility of a sign (e.g., factoring in land and building topology).

The supplemental data source functions as an optional component used to supply additional data. The supplemental data can may be used in combination with the visibility index, which reflects physical attributes of a D/OOH display, to provide advanced metrics related to the D/OOH display. In some variations, multiple supplemental data sources may be used. Examples of data provided through the supplemental data source can include traffic data, road properties (e.g., speed limits, road type, road size, number of lanes, direction of traffic), terrain data, population density data, demographic data, building/business location data, building map data, and/or other sources of information. These supplemental data sources may be used to augment or otherwise supplement the image data when determining a visibility score or other metrics like OTS or LTS scores.

In some variations, the system may include integration with integrated with Geographic Information Systems (GIS) to better understand the location, context, and surrounding environment of the OOH Displays. GIS data could provide crucial information such as road networks, land use, points of interest, and population densities which can help determine more accurate visibility index scores by considering additional geographic factors.

The supplemental data source may be an internally managed set of data. The supplemental data source could additionally or alternatively include data interfaces to externally managed and provided data sources.

The processing engine functions to determine a visibility index score for a display.

As discussed, the processing engine can include one or more processors with a one or more computer-readable mediums (e.g., non-transitory computer-readable mediums) storing instructions that, when executed by the one or more computer processors, cause the system to perform operations related to determining a visibility index score, an Opportunity To See (OTS) score, a Likelihood To See (LTS) and/or other D/OOH display attributes. The processing engine may process and analyze collected data to determine visibility scores/metrics of a D/OOH Display based on a set of predefined criteria. The criteria may include factors such as the size and orientation of the display, the distance and angle of view from the road, the speed and direction of traffic, and the weather conditions. The visibility determination module may employ machine learning algorithms to optimize the visibility determination process. For example, the configuration for determining the visibility index score may include operations such as detecting display position and display area in each image and calculating the visibility index score based on a set of images and their associated angles, distance, and/or viewable area. The instructions may additionally or alternatively facilitate any operation variations described herein.

The visibility index score and/or any generated metrics of the system may be used by some form of reporting module and/or application. Such reporting modules or applications may be implemented in the form of a marketplace platform, unique types of analytics-based user interfaces, advertisement auction/allocation systems, design tools, and/or other consumers of the visibility modeling uniquely enabled through the system. Such reporting modules and/or systems may provide insights to potential reach of viewership of the display and/or an expected number of viewers for a given display advertisement. The reports may also provide recommendations for optimizing the placement and content of the OOH Display.

In some variations, the system may include a marketplace platform which functions as a digital platform through which advertisements and other content can be booked for different D/OOH displays. The marketplace platform may integrate the visibility index scores into how the marketplace operates. The visibility index score may be used to alter how displays are priced, how advertising requests are dynamically matched to display options, how queries for displays are performed, and/or other applications. The marketplace platform may utilize the visibility score in driving various user interfaces.

In one variation, the marketplace platform could incorporate a user interface that visually ranks available D/OOH displays based on their visibility index scores. This feature would allow advertisers to quickly assess and compare the performance of different displays, enabling them to make informed choices about where to allocate their advertising resources.

In another variation, the marketplace platform may include an interactive map that displays the location of each D/OOH display along with its corresponding visibility index score and other relevant details. Advertisers could quickly filter and search for displays based on desired visibility criteria, ensuring they select the most suitable displays for their advertising campaign objectives.

In another variation, the marketplace platform could offer a user interface with customizable pricing sliders that are adjustable according to the visibility index scores of the D/OOH displays. Users could easily set their budget preferences and be presented with appropriate display options, helping them balance the cost against the expected visibility and impact of their advertisements.

In another variation, the marketplace platform may provide a guided campaign creation interface that uses display visibility data to recommend optimal advertising strategies. By inputting campaign objectives, target audience, and budget constraints, users would receive suggestions for display selection, ad content adaptation, and scheduling, all tailored to maximize the benefits of high-visibility displays.

In another variation, the marketplace platform could implement a real-time bidding interface for advertisers to compete for available D/OOH display inventory. The visibility index scores could be integrated into this process, acting as a weighting factor to determine the relative value of different displays and influencing bid pricing accordingly. This would promote more efficient allocation of advertising resources and fair competition among advertisers.

In some variations, the system may include a programmatic interface which functions as an interface through which external systems can integrate with the system. The programmatic interface can be implemented as a web application programming interface (API). API requests may be used to query properties of individual displays, search for displays matching particular visibility related properties, perform marketplace related actions, and/or other actions.

In one variation, one ore more external digital platforms may use the API of the system for driving processes within their systems. For example, other external D/OOH management platform may use an API to enhance their D/OOH management capabilities.

In some variations, the system may include a D/OOH display analysis dashboard interface, which functions as a data analytics interface into the display information. The display analysis dashboard interface may be configured to generate reports, perform data analysis, and/or perform other tasks used in understanding display-related data.

In some variations, the system may include a display design tool which functions to analyze content based on target display visibility. The design tool may additionally offer various dynamic deign features to optimize or enhance display content for D/OOH displays.

Some variation of the design tool could incorporate an interactive design editor with real-time visibility score feedback, automated design suggestions tailored to specific visibility scores, and/or a library of pre-built templates optimized for various visibility scenarios. These design features may enable users to make informed decisions and streamline the design process while ensuring effective advertisements for different OOH display situations. Additionally, the design tool component could provide design comparison and A/B testing tools for assessing different design variations based on the visibility scores of planned OOH displays.

In one exemplary variation, the display design tool may score two or more content options for a targeted display to indicate a recommended content option. In some variations, the display design tool may additionally augment or otherwise generate design assets. The display design tool may be used to adjust text formatting, text content, image content or format, and/or other aspects based on the visibility index score of the system. For example, text content and formatting may be adjusted to accommodate for the angle at which most viewers are expected to view the display.

### 3. Method

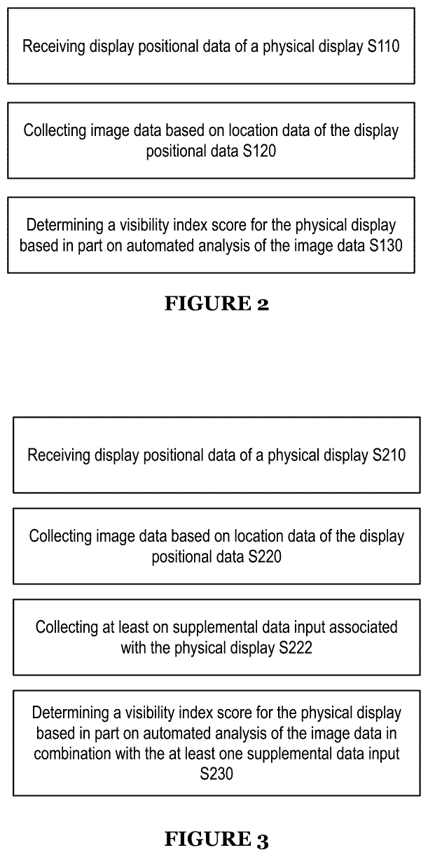

As shown in FIG. 2, a method for automatic determination of a D/OOH display visibility can include receiving display positional data of a physical display S110, collecting image data based on location data of the display positional data S120, and determining a visibility index score for the physical display based in part on automated analysis of the image data S130.

The method functions to use incorporation of visual data to automatically determine visibility attributes of D/OOH displays. It is preferably used to automate such analysis and determination across a large set of displays. The method may enable novel integration with one or more datasets that have no specific or direct relationship to advertising such as mapping related image data.

Different variations of the method may incorporate specific operations that enable enhanced functionality by integrating with alternative data sources, extracting granular attributes from data which were previously not associated with advertising, and/or enabling other forms of unique and previously unfeasible functionality. These enhancements may allow for more accurate and comprehensive analysis of Out Of Home Display visibility, opening up opportunities for businesses to gain deeper insights into campaign performance and optimize their advertising budgets accordingly, and enabling new capabilities and functionality within digital systems that support such operations.

In another variation shown in FIG. 3, a method for automatic determination of display visibility may incorporate additional exogenous factors and can include receiving positional data of a physical display S210, collecting image data based on location data of the display positional data S220, collecting at least one supplemental data input associated with the physical display S222 and determining a visibility index score for the physical display based in part on automated analysis of the image data in combination with at least one supplemental data input S230.

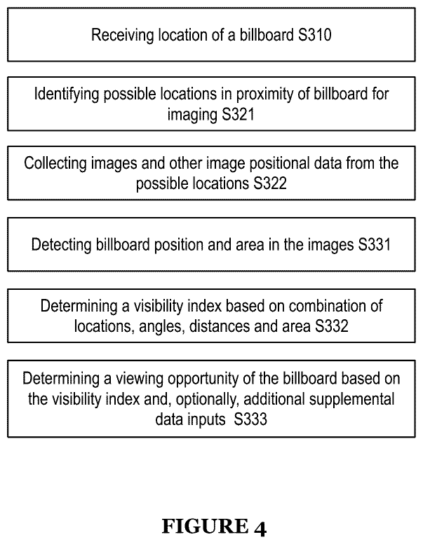

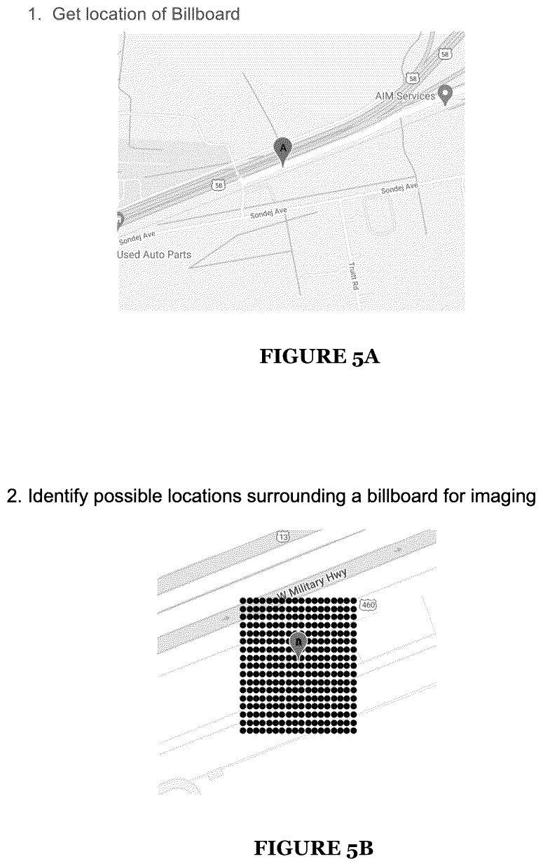

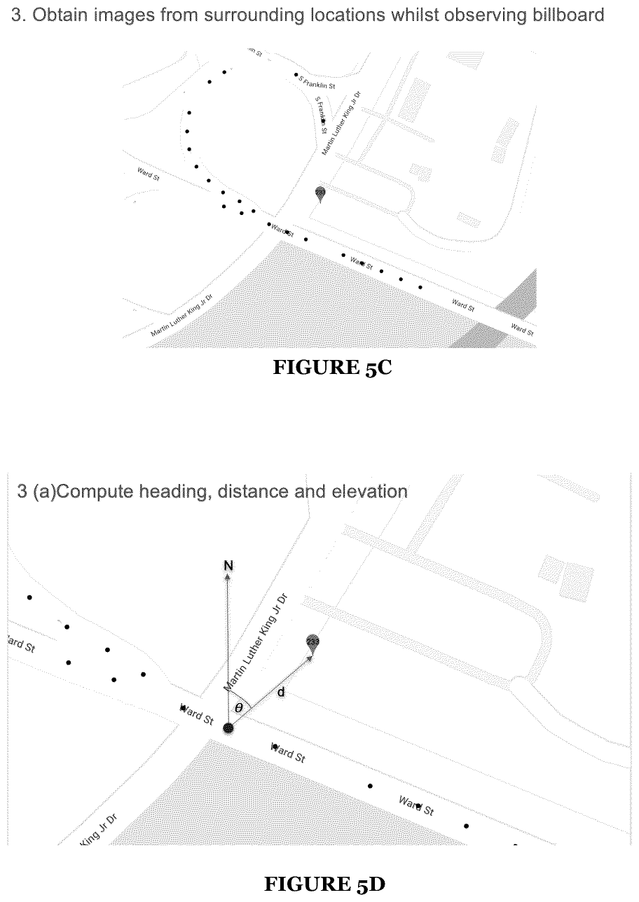

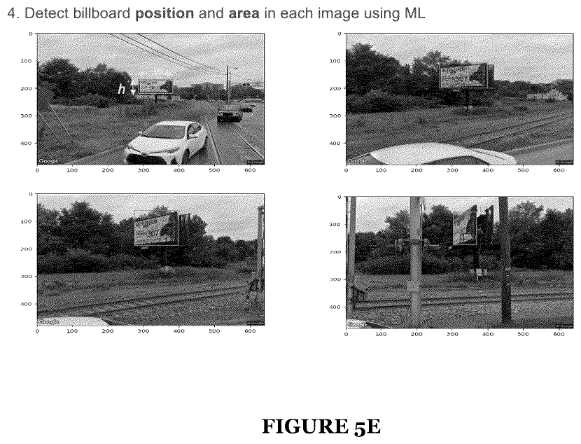

The method, in some variations, may be implemented so as to use image data extracted from a digital mapping service or some alternative image repository for determining a viewing opportunity score of a billboard/OOH display. In such a variation, the method may be implemented as shown in FIG. 4 to include receiving location of a D/OOH display S310 (e.g., FIG. 5A); identifying possible locations in proximity of the display for imaging S321 (e.g., FIG. 5B); collecting images and other image positional data (e.g., heading and distance) from the possible locations S322 (e.g., FIG. 5C and FIG. 5D); detecting billboard position and area in the images S331 (e.g., FIG. 5E); determining a visibility index based on combination of locations, angles, distances and area S332; and determining an Opportunity To See (OTS) of the D/OOH display based on the visibility index and, optionally, additional supplemental data inputs (e.g., exogenous variables such as traffic conditions of nearby roads) S333.

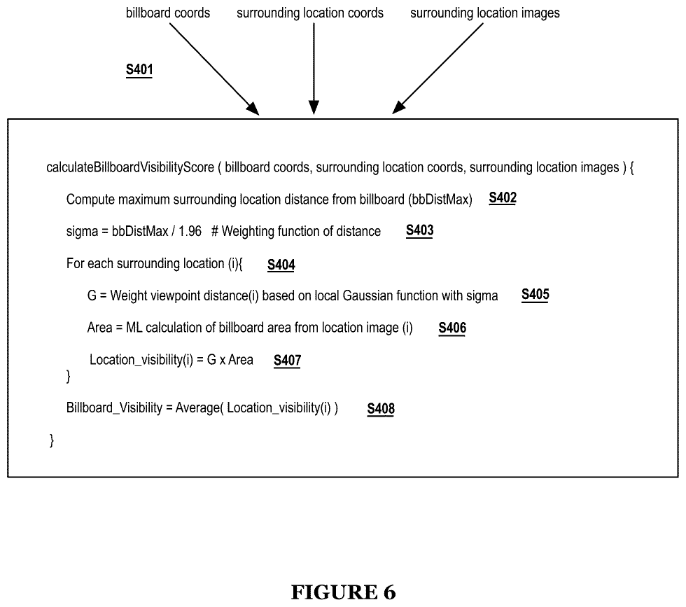

In one exemplary implementation, determining the visibility index score (such as in block S130, 230 or block S331-S333) can include, as shown in the exemplary FIG. 6, executing operations that take in input parameters of billboard coordinates S401; determining a maximum surrounding location distance from billboard (bbDistMax) S402; calculating a weighing function parameter (e.g., sigma=bbDistMax/1.96) S403; performing block S404 iteratively, wherein for each surrounding instance location (i) performing operations: determining a weighted viewpoint parameter (G) by weighting viewpoint distance based on a local Gaussian function S405, determining image area using machine learning (e.g., computer vision based determination of D/OOH display area from location image) S406, determining an instance location visibility index score for the instance location (LocationVisibility(i)) , which may be performed by calculating product of the weighted viewpoint parameter times the image area (i.e., G×Area) S407; and then determining the overall D/OOH display visibility (i.e., the visibility index score) by averaging the instance location visibility scores for each image instance (i.e., the set of instance location visibility scores) S408.

As discussed herein the determined visibility index score and/or other determined scores such as OTS of a D/OOH display may be incorporated into different applications whereby the scores are used to alter operations of a system such as API/analytics systems, advertising marketplace platforms, D/OOH media planning and booking platform, content management systems, display content design systems, and the like.

One variation of the method may be used in managing an API for display requests. The method can be used in enabling an API for querying the visibility and viewing scores for one or more D/OOH displays.

In another variation, the method may be used in providing a marketplace for planning and booking D/OOH displays. This variation can incorporate the visibility index, OTS, and/or LTS scores to facilitate automated pricing, automating auctions, and/or dynamic booking of D/OOH displays.

In another variation, the method may be used in evaluating and possibly creating or modifying content for a display.

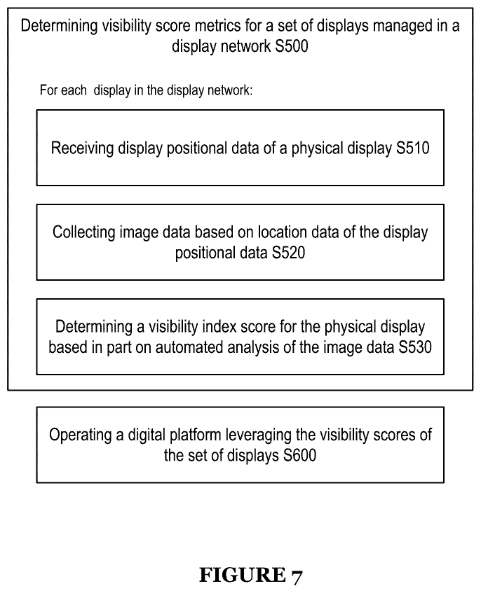

The method is preferably implemented in connection with a plurality of D/OOH displays. For example, the method may be performed across a large collection of D/OOH displays. However, the method may alternatively be used for one or a limited number of displays. When used for a plurality of displays, the method may comprise as shown in FIG. 7, determining visibility score metrics for a set of displays managed in a display network S500, wherein determining a visibility score for each display comprises for each display in the display network: receiving display positional data of an instance physical display S510, collecting image data based on location data of the display positional data S520, and determining a visibility index score for the physical display based in part on automated analysis of the image data S530; and operating a digital platform leveraging the visibility scores of the set of displays S600.

Operating the digital platform leveraging the visibility score may include such as managing an API for display requests, providing a marketplace, and/or providing design feedback as described herein.

Block S110, which includes receiving D/OOH display positional data of a physical display, functions to collect location information for one or more displays. In one variation, the display positional data can be supplied as a dataset including the longitude and latitude of a set of billboards. The display positional data may alternatively include other locating information such as positional information defined in terms of a specific environment like inside of a building.

In some variations, the display positional data may include or be associated with additional property data for the displays such as aspect ratio, dimensions, size, shape, width/height of display surface, direction of the display, display elevation, and/or other display properties. Accordingly, the method can include receiving display parameters of the physical display, where the display parameters may include any details about the type of display and its properties. The display property data may also include information on one or more potential display features such as if the display has lighting.

The display positional data may additionally include or be associated with usage information. For example, received data may include data records indicating the current displayed advertisement(s) for a D/OOH display and/or a historical data record of current/past advertisements. This may be used in detecting and identifying a display in image data of the distributed image dataset in block S120.

Herein, the examples are primarily described where the displays are outdoor displays like road-side billboards, but the method may additionally or alternatively be used for indoor displays or other advertising display formats and mediums. In such variations, the display positional data may be specified with additional or alternative details such as a position coordinates relative to a local coordinate system.

Receiving the D/OOH display positional data of a physical display may be received by querying or otherwise accessing an external data system that hosts display data or otherwise has access to such data. The external data system may be a third-party display advertisement platform or any suitable digital platform.

In another variation, receiving the D/OOH display positional data of a physical display may be performed through some interface (e.g., user interface, data interface, programmatic interface, or the like) from an account managing their displays within a digital system. For example, owners or operators of different D/OOH displays could add profiles for each display within the digital platform.

Block S120, which includes collecting image data based on location data of the display positional data, functions to dynamically select suitable image data for analysis of a display. Collecting image data preferably includes collecting image data samples in proximity to a location of the display indicated by the display positional data. Such collected image data may include the display within the image data. The image data can be collected from a data source that includes a large quantity of image samples. Collecting the image data samples can include querying a data source of the image data. This can include using an API to request image data at or near one or more locations based on the display positional data. In other words, requesting from an image data source image data associated with the display positional data. In one example, street-level images provided through a digital mapping service may be collected. In another example, a repository of geo-tagged user images may be searched and used as a source of some or all the image data.

While photographic imagery from the ground may be one option for image data, alternative sources of image data may be used to represent spatial and visual context in which a display resides. In other variations, image data may be formed from, replaced by, or supplemented with satellite imagery, topographical or 3D modeling of a geographic region, or other image or spatial data.

In one variation, image data may be collected within a set distance threshold. In another variation, image data may be collected dynamically within suitable locations in proximity to the display. Accordingly, collecting the image data may include identifying possible locations surrounding or in proximity the display, which functions to determine suitable locations. Identifying possible locations may include modeling viewable range from the display location (e.g., a location indicated in the display positional data), which may factor in display direction and geographic features such as topology, buildings, view obstructions (e.g., like trees or other structures etc.), and/or other factors impacting visibility. Identifying possible locations may additionally include identifying roads, paths, or other viewing areas of interest.

In connection with identifying the possible locations surrounding the display, block S120 may include collecting image data associated with at least a subset of identified locations (e.g., at those locations, from within some threshold distance from those locations, within some region defined by one or more location, etc.).

In some cases, the location of the display, the surrounding buildings or land formations, roads, pedestrian regions, and/or other factors can impact where image data samples may be particularly useful. A mapping service with image data may be queried to see if image data is available within those locations that may possibly include images that capture the display. When an image sample is collected, the heading, distance, and/or elevation properties of the image relative to the display may also be collected.

In some variations, collecting image data may include detecting the presence of the display in an image. For each image, computer vision and/or a suitable machine learning model can be applied to the detection of the display within the image. More specifically, this may include performing computer vision processing the image data and thereby detecting the presence of the display in the image data. This may be a generalized display detection process. For example, a CV model trained on a dataset of images including displays (e.g., billboards, bulletins, bus shelters , etc.), which once trained can be used for generalized detection and optionally segmentation. In another variation, display content history or current content state may be used to detect and identify presence of a display. For example, an image could be analyzed for detecting a display with advertisement content previously displayed on the display. This may be used to differentiate between multiple displays, which may be captured in the same region or even within the same image. For example, if an image captures multiple billboards, the content of the billboards can be used to uniquely associate each imaged billboard with the actual billboard. In other variations, other properties such as size, display type, and/or other display properties may additionally or alternatively be used in identifying a display.

In some instances, images within a proximity may be collected that do not include the D/OOH display. These images may be skipped or omitted from determining a visibility score. Alternatively, images that omit the display may be used to define contact zone, or inform regions with lack of visibility of the display. For example, a display not detected in an image with an angle and proximity expected to capture the display may indicate that some obstruction (e.g., a tree or other structure) is blocking the display.

As mentioned, in some variations, the method can additionally include collecting at least one supplemental data input associated with the physical display as shown in FIG. 3, which functions to incorporate other exogenous factors into assessment of a D/OOH display. Collecting supplemental data input may include one or more of: collecting traffic data of nearby roads, collecting data on road properties (e.g., speed limits, road type, road size, number of lanes, direction of traffic), collecting terrain data near the display location, collecting population density data, collecting demographic data, collecting building/business location and characterizing data, and/or collecting other types data on the region near the display location or that may impact the scoring of the D/OOH display or audience related metrics (e.g., the visibility index, OTS, LTS scores).

Block S130, which includes determining a visibility index score for the physical display based in part on automated analysis of the image data, functions to analyze and transform the collected data into at least one metric related to the visibility of the display. In some variations, the output of block S130 is a visibility index score for a display. In other variations, the output may include an OTS score and/or other metrics related to the quality and/or number of views of the display. Determining a visibility index score can preferably incorporate the detection of a display across a set of sample images collected during block S120, such that the visibility index scores will be a metric representing more general visibility of a display based on multiple digital image samples.

Determining a visibility index score can include detecting display position and display area in each image and calculating the visibility index score based on a set of images and their associated angles, distance, and display area.

Detecting the display position and display area in each image functions to assess the visible presence of a display in a given image. In some instances, a set of different images from different points of view (e.g., from different angles and distances) will capture the display. How the display looks in those images can be used. In some variations, the angle of the display can be assessed based on the perspective skew of the display region. A machine learning model may be trained to perform such display detection and area and/or angle measurements.

Calculating the visibility index score can function to perform a group assessment of the data detected from individual images and/or other supplemental data sources. In one variation, the properties extracted from various image instances can be combined using a Gaussian function (or other suitable function) to combine image location information, angle information, distance information, image area and/or angle data, and/or other properties into one or more metrics that relate to an assessment of visibility taken from a broad perspective. Accordingly, calculating the visibility score can include determining/calculating the visibility index score based in part on combining, using a Gaussian function, image location information, angle information, distance information, image area and angle data.

As shown in FIG. 6, such a process may be implemented by creating metrics around individual visibility index scores from a set of images and then averaging them into an overall visibility index score.

In one exemplary variation, calculating a visibility index score may include for each image instance of the collected image data, determining image area of the display in each image instance, determining an instance location visibility score for a location of each image instance, and determining an overall display visibility index score by combining the set of instance location visibility scores.

Determining image area of the display in each image instance may include determining the image area using machine learning process to detect and/or measure/characterize display area. This may employ using computer vision analysis of an image instance to measure display area of a D/OOH display. Different machine learning models may be used to provide different measurement capabilities. On variation may provide an area or spatial measurement. Another variation may provide a graded measurement based on area and angle to account for displays being more or less angled towards the location. Another variation may provide measurement that factors in obstructions and/or distractions in proximity. For example, such a model may score a billboard with no nearby structures higher than a display next to many distracting objections in near proximity. Combining the set of instance location visibility scores can include averaging the instance location visibility scores.

Some variations may additionally include determining a weighted viewpoint parameter (e.g., based on a local Gaussian function). The weighted viewpoint parameter may be used in weighting the impact of the instance location visibility scores when determining an overall display visibility index score. Accordingly, some variations calculating a visibility index score may include for each image instance of the collected image data, determining a weighted viewpoint parameter for location of each image instance, determining image area of the display in each image instance, determining an instance location visibility score for a location of each image instance, and determining an overall display visibility index score by combining (e.g., averaging) the set of instance location visibility scores weighted by associated weighted viewpoint parameters.

In other variations, the method may incorporate a model of visibility where visibility can be a function of spatial position. This may enable a heatmap data representation of a visibility index score. This data-based interpretation of visibility of a display may be used so that the D/OOH display can be analyzed in more detailed forms. For example, a system could inspect the visibility of a display for vehicles, pedestrians, viewers, and take different actions based on the situation.

When visibility scores are mapped by spatial locations, then the method may include classifying visibility scores by viewer type. For example, the visibility scores across a spatial region associated with a pedestrian area (e.g., sidewalks, pedestrian paths, etc.) may be aggregated into a pedestrian visibility score. A pedestrian visibility score may function to reflect the visibility by pedestrians. Similarly, visibility scores across spatial regions associated with vehicles (e.g., roads) may be aggregated into a vehicle visibility score. A vehicle visibility score may function to reflect visibility by people traveling by a vehicle.

The assessment of the display may be further refined by incorporation of collected supplemental data. For example, the traffic data, population data, building/business location data can be used to augment predictions related to OTS.

In addition to calculating and/or determining an index score, the method may include determining and/or calculating an OTS (Opportunity to see) and/or a LTS (likelihood to see) score based in part on the visibility score. The OTS and/or LTS may use additional factors such as population mapping data, traffic data, and/or other factors that can be combined with the visibility index score to create enhanced predictions on OTS and LTS. Determining OTS and/or LTS scores, in some variations, may comprise using visibility index score to identify regions where a display has elevated visibility (e.g., visibility above some threshold) and then account for the predicted number of people and time to see the sign.

In one variation, the visibility index score, OTS score, LTS score, impression metrics, and/or other metrics may introduce a time variable based on temporal patterns and/or real-time conditions. The viewing opportunity score may vary as a function of the time of day and day of week based on historical traffic trends. For example, more people may be able to see a billboard during morning traffic compared to afternoon/evening traffic times. Accordingly, the method may include calculating OTS and/or LTS scores as a function of time. The time period for predicted scores may be predictions by time of day and/or date in a year.

As discussed, some variations of the method can include determining a visibility index score for the physical display based in part on automated analysis of the image data in combination with at least one supplemental data input, which functions to use exogenous factors in adjusting the scoring of a display. This process may be more generally applied to generate an OTS score based on the combination of visibility index and the supplemental data. In one variation, speed of roads in near proximity may be used in weighting the display.

In another variation, traffic conditions (possibly as a function of time) may be factored in. Predicted audience composition may similarly be incorporated. For example, a D/OOH display near many business buildings may be scored differently from a display in a more suburban area. This can include performing a proximity search of nearby points of interest and factoring that into the visibility index score. Performing such a proximity search may be used in identifying a list of different businesses, types of buildings (residential, mixed-use, commercial, industrial, park space, etc.).

In some variations, the scoring of a display can be performed as a function of time. This may be used to adjust scoring based on historical patterns over time and/or real-time conditions. For example, traffic may impact visibility so that the OTS and/or LTS scores are a function of time where the score could be one score value during morning rush hour, a second score value during off-traffic hours, and a third score value during evening rush hour. The method may use real-time data to dynamically adjust derived metrics such as OTS and LTS. This may enable new dynamic digital advertising opportunities for D/OOH displays. For example, if there is unexpected traffic in a section of a highway near a digital billboard, a digital ad management system may dynamically update the digital billboard based on expected increase in OTS and LTS. Furthermore, visibility score and/or related metrics may be used to adjust the content of the D/OOH display to account for changing speeds of viewers.

The method is preferably used to alter the operation of a system in one or more ways.

In one variation, the method can include providing a programmatic interface, which functions to expose data analysis of one or more D/OOH displays for interaction with other systems. Providing the programmatic interface may be used as part of managing an API for display requests. The programmatic interface can be an application programming interface (API) such as a REST API or other suitable type of API. Providing the programmatic interface can include receiving D/OOH display query requests, accessing D/OOH display associated visibility index, OTS and LTS scores, and/or other determined metrics. The API may be used to interface with D/OOH planning and trading platforms, and with digital content management software (e.g., systems used to automatically manage and update content of digital displays).

In one variation, the method can include providing a D/OOH or other form of out of home marketplace, which functions to operate a D/OOH marketplace at least partly based on the visibility index scores, OTS scores, LTS scores, and/or other display assessments. Providing the marketplace may be used for planning and/or booking D/OOH displays. Providing the marketplace may include generating D/OOH display recommended pricing based on one or more display assessments. The display assessments may be characterizations of a display that include or based in part on visibility index score. For example, an advertiser could browse possible D/OOH displays, and the D/OOH display options may have prices set based in part on the score output of the method (e.g., having an OTS/LTS based price). In another variation, providing the marketplace may additionally or alternatively include matching display queries to displays based on one or more display assessments. For example, an advertisement may search or browse potential D/OOH display options within the marketplace based on targeted audience size, demographics, OTS scores, and LTS scores.

In another variation, the method can include automatically selecting display content based at least in part on visibility index scores, OTS scores, and/or other display assessments. For example, a certain advertising creative may be displayed on a billboard based on an accurate OTS, LTS, where the viewing of the display can be a function of a visibility index score and real-time audience measurement and attributes. Display content (e.g., advertisements may be automatically served to digital OOH displays according to visibility index scores. In some variations, the derived OTS and/or LTS scores that factor in the visibility index scores may be used to serve display content. The display content could be served so that the display content is active at a display to satisfy some predicted number of viewers have seen or have had an opportunity to have seen the display.

In another variation, the method may include providing display content feedback based in part on a visibility index score, OTS score, and/or other display assessment.

Providing display design creative feedback may include generating a design comparison, which functions to perform a comparative rating of design creative determined in part by the visibility index score. This may be implemented as a type of A/B test where the potential performance of creative can be rated based on how it will be viewed on a particular display. This display content comparison feature may involve receiving two or more potential display content samples, evaluating visibility based in part on the visibility index score. This functions to account for primary viewing angle, amount of time to view the content, and/or other factors. It may then recommend one potential display content sample if determined to be a preferred option from a visibility standpoint.

Providing display content feedback may include performing a content validation assessment based in part on visibility index score of the display. This may be used to assess various aspects of the content such as readability and/or visual detail. The content validation assessment can report on text size, text content length, image size, visual contrast, and/or other aspects. This can be used to enable an advertiser to determine if the graphical design of an advertisement should be updated and or altered before using with a billboard. In practice, this feature may involve receiving sample display content, processing the display content for visibility at a D/OOH display based in part on the visibility index score of the D/OOH display, and outputting design feedback. The feedback may indicate one or more features that satisfy some design criteria and/or issue a warning or flag issues regarding some design criteria.

In some variations, providing display content feedback may additionally include A/B testing for a Creative Design or content. This can make content adaptive to different displays based on their visibility index scores or other assessments/scores. In one example, the text formatting used within a particular advertising creative (i.e., graphical design) may be adjusted for different D/OOH displays according to the visibility index. In another example, the graphical assets (e.g., images) used within a particular advertising creative may also be adjusted for different D/OOH displays according to the visibility index. In this way, an advertisement may be deployed for displaying in a number of different D/OOH displays across a country, but some variables relating to how the content is formatted can be dynamically adjusted according to each individual display's visibility index score. In one implementation variation, the content of a D/OOH display may be defined using a markup language such as HTML so that the content can be dynamically adjusted for different display sizes and dimensions and visibility scenarios.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: receiving display positional data of a physical display, collecting image data based on location data of the display positional data, and determining a visibility index score for the physical display based in part on automated analysis of the image data.

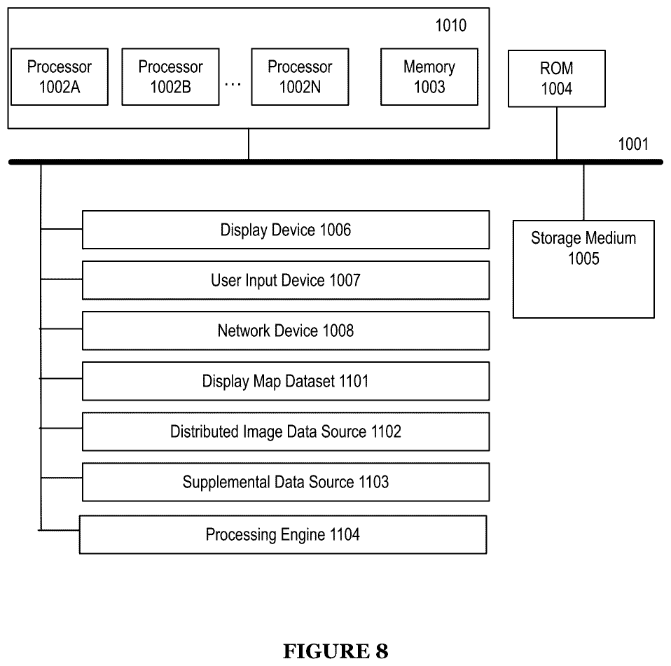

FIG. 8 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting a display map dataset 1101, distributed image data source 1102, supplemental data source 1103, processing engine 1104 and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method for a digital system managing a plurality of out of home displays comprising:
receiving display positional data of a physical display;
collecting image data based on location data of the display positional data;
determining a visibility index score for the physical display based in part on automated analysis of the image data.

2. The method of claim 1, wherein determining the visibility index score for the physical display based in part on the automated analysis of the image data comprises detecting display position and display area in each image and calculating the visibility index score based on a set of images and their associated angles, distance, and display area.

3. The method of claim 1, wherein determining the visibility index score for the physical display based in part on the automated analysis of the image data comprises: for each image instance of the collected image data, determining image area of the display in each image instance, determining an instance location visibility score for a location of each image instance, and determining the visibility index score by combining the instance location visibility scores for each image instance.

4. The method of claim 1, wherein collecting image data based on location data of the display positional data comprises collecting image data samples in proximity to a location of the display indicated by the display positional data.

5. The method of claim 4, wherein collecting image data samples is collected from a street-level mapping data set.

6. The method of claim 4, further comprising performing computer vision processing of the image data samples and thereby detecting a presence of the physical display in the image data.

7. The method of claim 1, further comprising collecting at least one supplemental data input associated with the physical display; and wherein determining the visibility index score for the physical display based in part on the automated analysis of the image data comprises determining the visibility index score for the physical display based in part on automated analysis of the image data in combination with at least one supplemental data input.

8. The method of claim 1, wherein collecting image data based on the location data of the dispolay positional data further comprises identifying possible locations in proximity to the display and collecting image data samples associated with at least a subset of identified locations, wherein identifying possible locations comprises modeling viewable range from a location indicated in the display positional data, factoring in display direction and geographic features.

9. The method of claim 1, further comprising determining an opportunity to see score and a likelihood to see score based in part on the visibility score.

10. The method of claim 9, further comprising providing an out of home display marketplace at least partly based on the visibility index scores.

11. The method of claim 1, further comprising providing a programmatic interface to visibility index score of the physical display.

12. The method of claim 1, further comprising receiving display content for the physical display and providing display design creative feedback based in part on the visibility index score.

13. The method of claim 1 wherein the physical display is a display type selected from the set of billboards, digital signs, urban panels, and spectaculars.

14. A non-transitory computer-readable medium storing instructions that, when executed by one or more computer processors of a computing platform, cause the computing platform to perform operations comprising:
receiving display positional data of a physical display;
collecting image data based on location data of the display positional data;
determining a visibility index score for the physical display based in part on automated analysis of the image data.

15. The non-transitory computer-readable medium of claim 14, wherein determining the visibility index score for the physical display based in part on the automated analysis of the image data comprises detecting display position and display area in each image and calculating the visibility index score based on a set of images and their associated angles, distance, and display area.

16. The non-transitory computer-readable medium of claim 14, wherein determining the visibility index score for the physical display based in part on the automated analysis of the image data comprises: for each image instance of the collected image data, determining image area of the display in each image instance, determining an instance location visibility score for a location of each image instance, and determining the visibility index score by combining the instance location visibility scores for each image instance.

17. A system comprising of:
one or more computer-readable mediums storing instructions that, when executed by the one or more computer processors, cause a computing platform to perform operations comprising:
receiving display positional data of a physical display;
collecting image data based on location data of the display positional data;
determining a visibility index score for the physical display based in part on automated analysis of the image data.

18. The system of claim 17, wherein determining the visibility index score for the physical display based in part on the automated analysis of the image data comprises detecting display position and display area in each image and calculating the visibility index score based on a set of images and their associated angles, distance, and display area.

19. The system of claim 17, wherein determining the visibility index score for the physical display based in part on the automated analysis of the image data comprises: for each image instance of the collected image data, determining image area of the display in each image instance, determining an instance location visibility score for a location of each image instance, and determining the visibility index score by combining the instance location visibility scores for each image instance.
